(19) United States
(12) Patent Application Publication
(10) Pub. No.: US 2003/0155027 A1
(43) Pub. Date: Aug. 21, 2003

(54) Composite interference pulsation dampener

(76) Inventors: Vladimir Abramovich Michlin, Yoqneam Illit (IL); Igor Igorevich Stukanov, Yoqneam Illit (IL)

Correspondence Address: VLADIMIR MICHLIN, APT. 6, 27 ZEELIN STR., YOQNEAM ILLIT, 20692, IL

(21) Appl. No.: 10/079,686

(22) Filed: Feb. 21, 2002

(51) Int. Cl. F16L 55/04

(52) U.S. Cl. 138/42; 138/26

(57) ABSTRACT

A composite interference pulsation dampener that has no moving parts, which results in the high reliability and efficiency of the dampener on wide intervals of frequencies, temperatures, pressures, and flow velocities.

The device consists of modified interference disks separated by spacers, a hood, and covers. A modified interference disk is a hard disk with a central channel, secondary channels, and orifices/holes. The configuration of the device is optimized to reach a desirable performance in a given hydraulic/pneumatic system and to minimize the sizes, weight, and cost of the device.

### CROSS-REFERENCE TO RELATED APPLICATIONS

Not Applicable

### STATEMENT REGARDING FEDERALLY SPONSORED RESEARCH OR DEVELOPMENT

Not Applicable

### REFERENCE TO A MICROFICHE APPENDIX

Not Applicable

### BACKGROUND OF THE INVENTION

1. Field of the Invention

This invention relates to a pulsation dampener and particularly to an apparatus that reduces the effect of pulsations of liquid/gas flow in a hydraulic/pneumatic system that includes a pumping device.

2. Background Information

Pulsations and accompanying vibrations and noises, arising as a result of a pumps' work, are responsible for additional loads exceeding the average pressure in the system. As a result, the hydraulic system is exposed to negative influences that reduce the exploitation terms and increase the risk of a crash.

Depending on the significance of the system (airplane, oil pipeline, etc.), the results of a crash may have catastrophic consequences.

To reduce the risk of a breakdown due to pulsations in the system, manufacturers increase the thickness of the walls in the pipelines of hydraulic systems. As a result the price and the weight of the systems are increased. To reduce the costs and weight of hydraulic systems, pulsations dampeners are used.

Some of last patents in the pulsations-reduction field deal with changes of pump design, and therefore they are not applicable to the pumps/systems that exist today or to future systems that will rely on traditional pumps. Systems in which such pulsations modified pumps are used will be expensive compared with systems where traditional pumps are used.

Today the majority of companies use separate devices—pulsations dampeners to reduce pulsations in hydraulic systems. There are two approaches to solving this problem using these devices.

The first approach consists in using a dampening element (for example, volume of gas/fluid separated by membranes or forcers from the main flow) to absorb or damper pulsations in the flow.

More than a one hundred inventions based on this method have been proposed. The most advanced dampeners of this type are described in U.S. Pat. Nos. 4,273,158 Chun, No. 5,505,228 Summerfield, No. 5,797,430 Becke, No. 5,860,452 Ellis, No. 6,086,336 Welschof, and Russian Patents No. 2,029,906 Prokhorov, and No. 2,156,912 Nizamov.

All devices of this type have low reliability due to the existence of moving parts such as membranes/forcers. In addition, they require frequent monitoring and adjustment of working parameters such as pressures of absorbing/dampening volumes.

The second approach consists in using the interference of 180°-degree phase-shifted waves to reduce pulsations in a system. U. S. Pat. Nos. 5,145,339 Lehrke and No. 5,993,174 Konishi disclose pulseless pumps in which the phase-shifted waves are created in separate cylinders of the pump. These constructions are very efficient but still not reliable. They are also complex and have a narrow sphere of applications.

U.S. Pat. Nos. 5 957664 Stolz; No. 6,155,378 Qatu; and No. 6,279,613 Chen disclose dampeners in which phase-shifted waves are formed by reflections from parts of the devices. These constructions are more reliable than previous compositions, but are less efficient due to energy losses during reflections. In addition, in systems with long-length-waves the dampeners have big sizes.

Russian Pat. No. 626 304 Michlin discloses a dampener in which a phase-shifted wave is formed in a secondary channel of an interference disk. This dampener has none of the drawbacks of the previous inventions, but it is only applicable to a narrow interval of frequencies and is not compact enough in the case of high-frequency pulsations.

The present invention is an advanced/improved modification of the previous dampener, which is cheap to produce, highly reliable, and highly efficient for a wide ranges of temperatures, frequencies, pressures, and flow velocities.

### BRIEF SUMMARY OF THE INVENTION

The present invention is a compact and reliable interference pulsation dampener for hydraulic/pneumatic systems, which consists of a one or several interference disks separated by spacers and placed under the hood of the device or pump.

The disks are designed and placed in a way, that maximize the efficiency of the dampener on required spectrums of frequencies of the pulsations, temperatures, pressures, and velocities of a flow in the system. The modified interference disks, in addition, allow to minimize sizes of the device by means of reduction to minimum the non-working spaces of the disks and the material capacity of the dampener.

The interference disk has central and secondary channels that separate the initial pulsated flow into several flows in which 180-degree phase-shifted waves of pulsations are formed. These waves interfere where the channels are connected which results in the reduction of pulsations in the output flow. If there is a need for additional reduction of pulsations, another disk is placed consequently in the device. To minimize the diameter of the disk, a geometric configuration of the secondary channels is optimized by means of combinations of corresponding spirals, and segments of arcs. The disk may have additional orifices and reflective shields to reach desired performance for the required spectrum of pulsations frequencies.

### BRIEF DESCRIPTION OF THE SEVERAL VIEWS OF THE DRAWINGS

FIG. 1. A composite interference pulsations dampener for the reduction of high-frequency pulsations.

FIG. 2A. A modified interference disk for dampening of high-frequency pulsations.

FIG. 2B is a cross-sectional view of the modified interference disk of the FIG. 2A taken along the line A-A.

FIG. 3. The composition of modified interference disks for the high-frequency pulsations dampener.

FIG. 4. A composite interference pulsations dampener for the reduction of low-frequency pulsations.

FIG. 5. The composition of modified interference disks for the low-frequency pulsations dampener.

FIG. 6. A composite interference pulsations dampener for the reduction of average-frequency pulsations.

FIG. 7A. A modified interference disk for the dampening of average-frequency pulsations.

FIG. 7B is a cross-sectional view of the modified interference disk of the FIG. 7A taken along the line A-A.

FIG. 7C is a side view of the modified interference disk of the FIG. 7A taken along the direction E.

FIG. 8. A pulseless pump with an embedded interference disk.

FIG. 9 is a list of the details/parts of the invention.

FIG. 10 The mechanics of pulsation dampening in an interference disk.

FIG. 11. Amplitudes of pulsations with and without the dampener on a range of frequencies.

FIG. 12. Amplitudes of the pipes' vibrations with and without the dampener for different frequencies.

FIG. 13A. Dependencies of pulsations on temperature at 450 hertz.

FIG. 13B. Dependencies of pulsations on temperature at 900 hertz.

### DETAILED DESCRIPTION OF THE INVENTION

The present invention is directed to a pulsation dampener for hydraulic or pneumatic systems and is described below in several examples.

### EXAMPLE 1

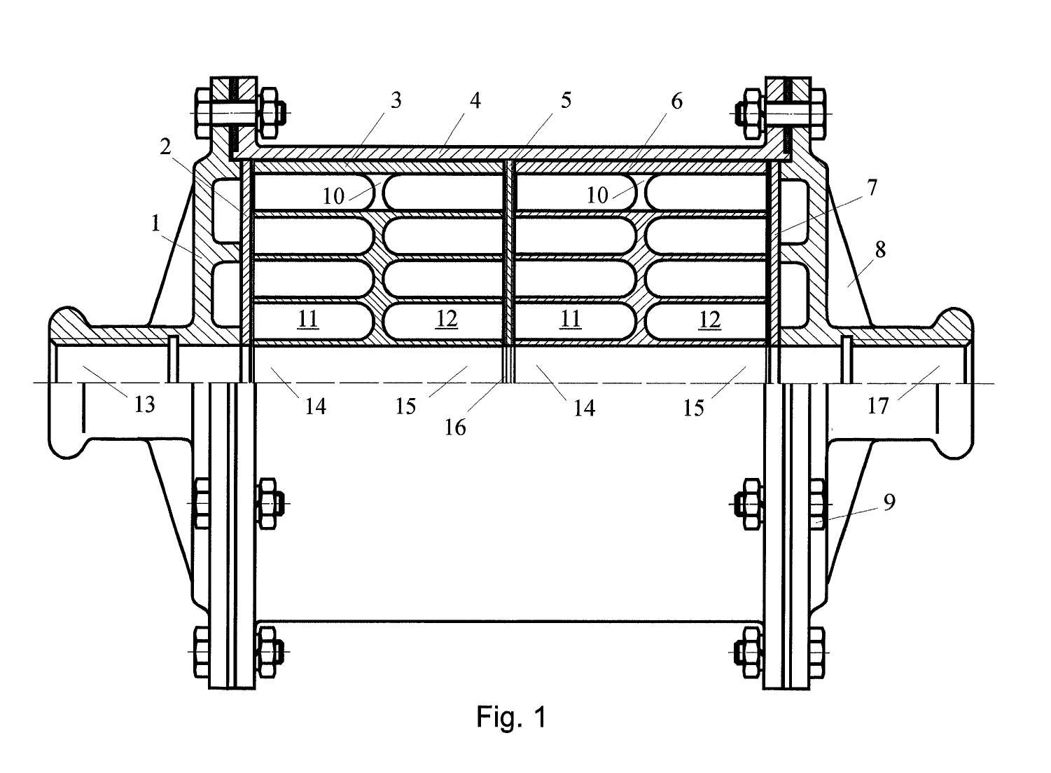

The dampener shown in FIG. 1 consists of cover 1 with input channel 13; hood 4; interference disks 3 and 6; spacers 2, 5, and 7; and cover 8 with output channel 17. The covers and hood are secured by nuts 9 and are constructed of a rigid material capable of withstanding the internal pressure created by the fluid within the secondary channels.

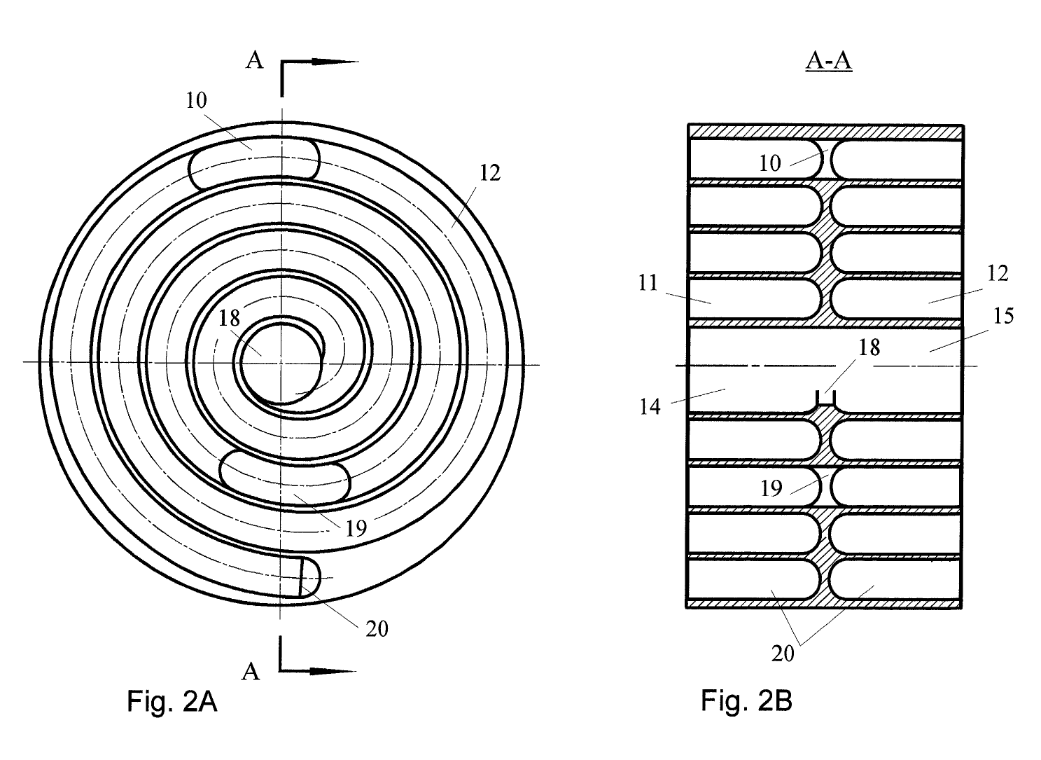

The modified interference disk shown in FIGS. 2A and 2B is a hard disk with a central channel consisted of input part 14 and output part 15, and secondary channels formed by notches 11 and 12 on the sides of the disk, orifices 10 and 19, and reflective shields 20. The geometrical form of the notches consists of pieces of spirals and arcs of a circle to minimize the diameter of the disk.

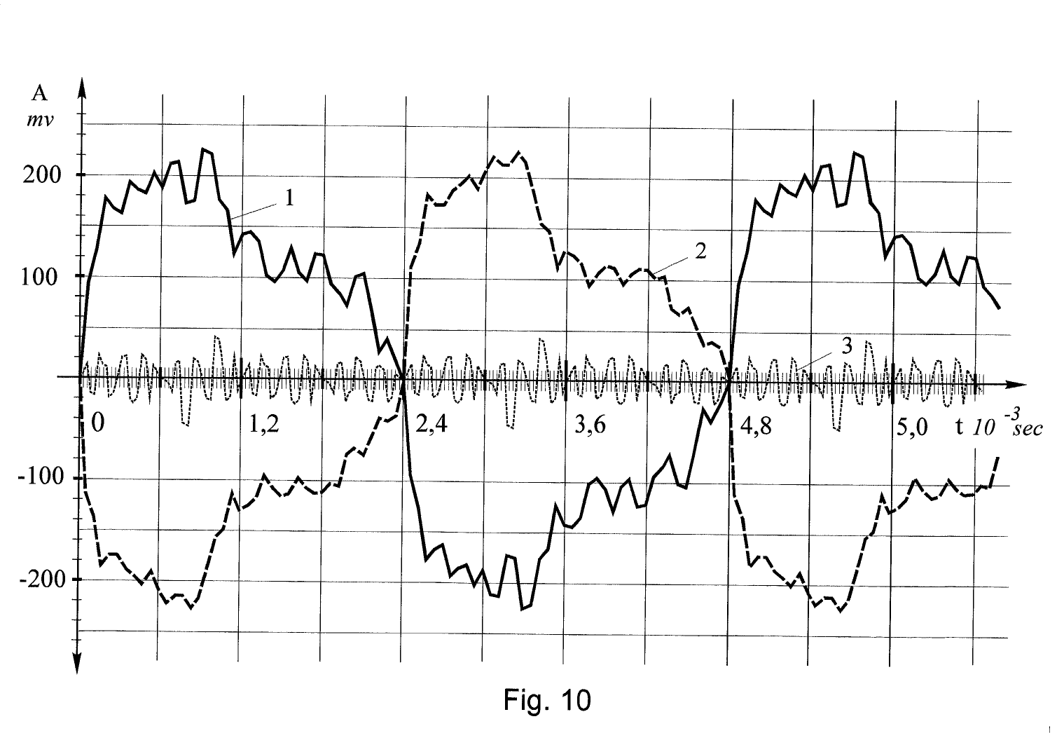

The function/purpose of the secondary channel is to form a 180-degree phase-shifted wave for a given frequency of pulsations. The phase-shifted waves formed in the secondary channels interfere with the original wave in the central channel, and as result, the output flow with reduced pulsations is formed in the cavity 15. In FIG. 10 the mechanics of this process is shown.

The distances between orifices 18 and 19, and between orifice 18 and the shield 20 are chosen in a way that provides efficient pulsations reductions on a required range of frequencies from f1 to f2. The orifice 19 is placed approximately half the distance (along the notch 12) between the center of the disk and the center of the orifice 18. This design provides reductions of pulsations in the range of frequencies from 2f1 to 2f2 (secondary harmonics).

The second disk 6 accomplishes further/additional reduction of pulsation, which result in a required level of pulsations' dampening in the flow from the output channel 17 of the device.

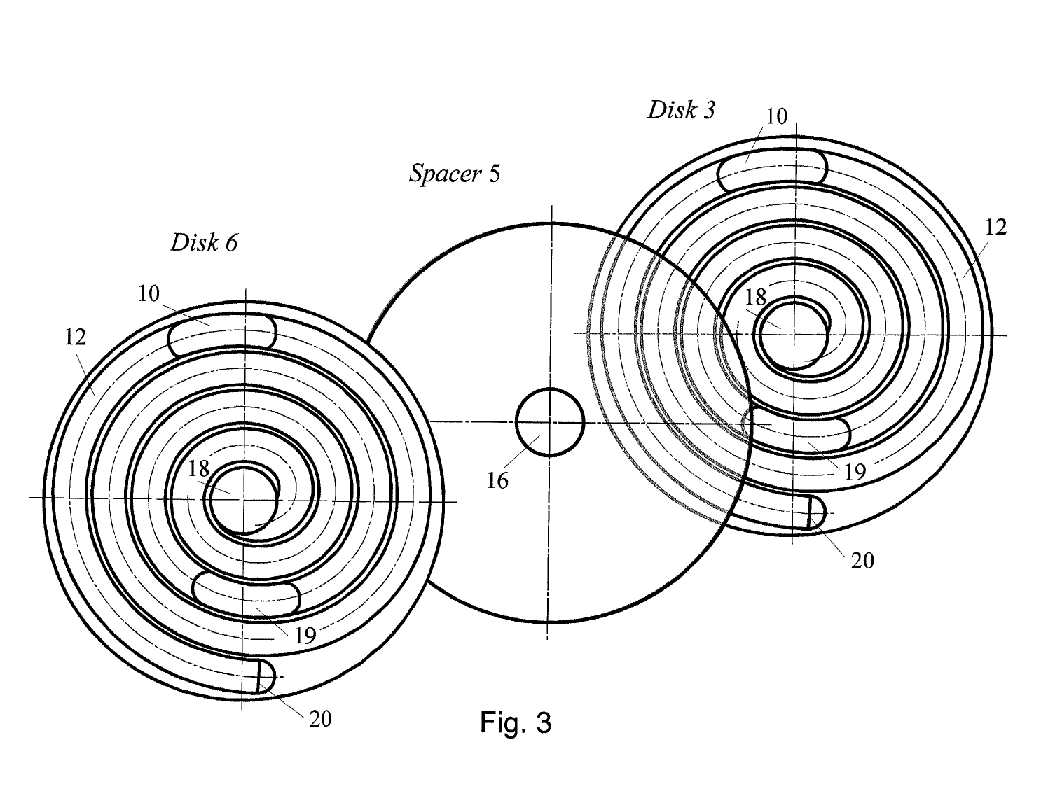

FIG. 3 shows the composition of the disks 3, 6 and the spacer 5. The channels of the disks are connected via the orifice 16.

The main advantages of this device are high efficiency and reliability on wide ranges of temperatures, pressures, and velocities of the flow.

The next advantages are the smaller sizes of the device and minimal material capacity of the disks. This is achieved by means of superposing axes of central channel, spirals and arcs of secondary channels.

The next advantage of this device is the efficient reduction of pulsations in a wide range of pulsations' frequencies, which is achieved by the additional orifice 19 and reflective shields 20. This advantage is very useful in systems where frequency of pulsations is varied in a some range, for example in airplane hydraulic systems during different stages of the flight.

### EXAMPLE 2

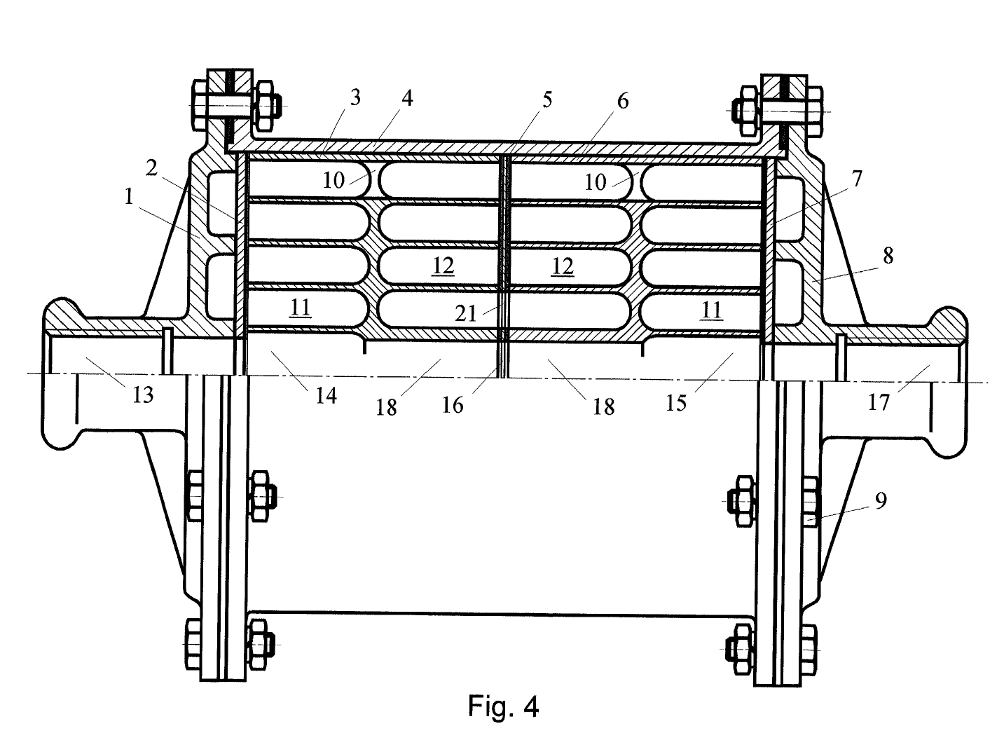

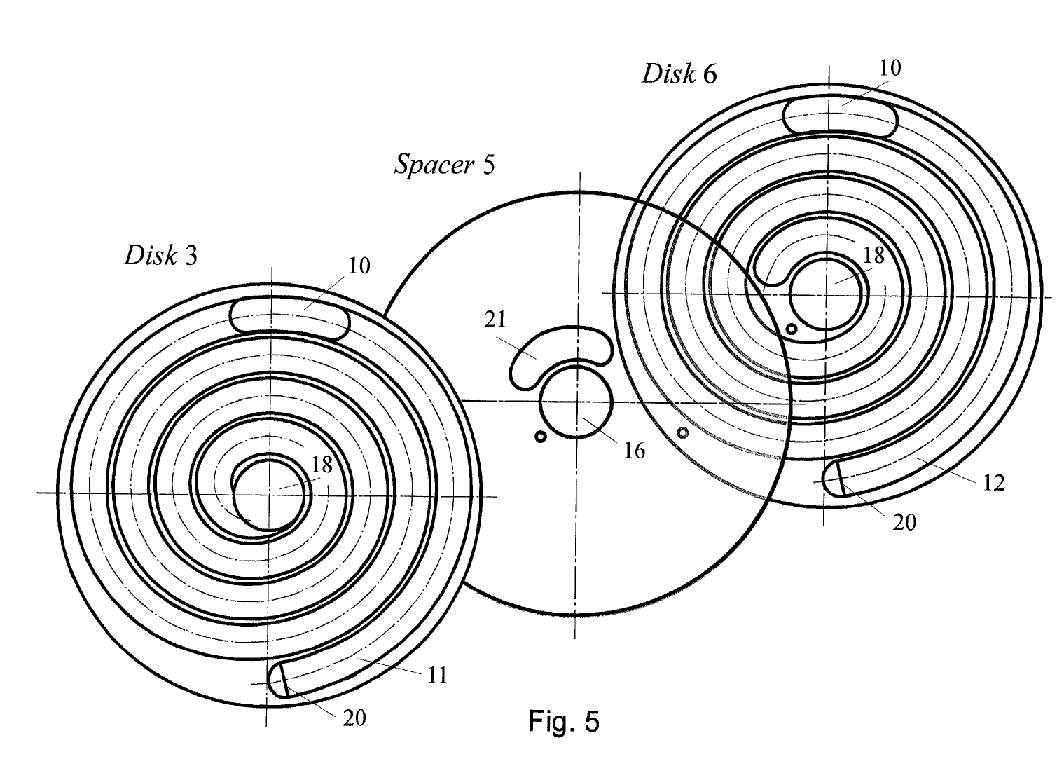

The dampener shown in FIGS. 4 and 5 differs from the dampener of the example 1 in the construction of the spacer 5 and the absence of the connection between the central and secondary channels on the disk In this case the spacer 5 has the additional orifice 21 via which the secondary channels of the disks are united and form the single secondary channel. This type of construction allows the reduction of low-frequency pulsations without increasing the diameter of the disks, which results in compactness of the dampener.

Other notations in the FIGS. 4, 5 are the same as in FIGS. 1-3.

### EXAMPLE 3

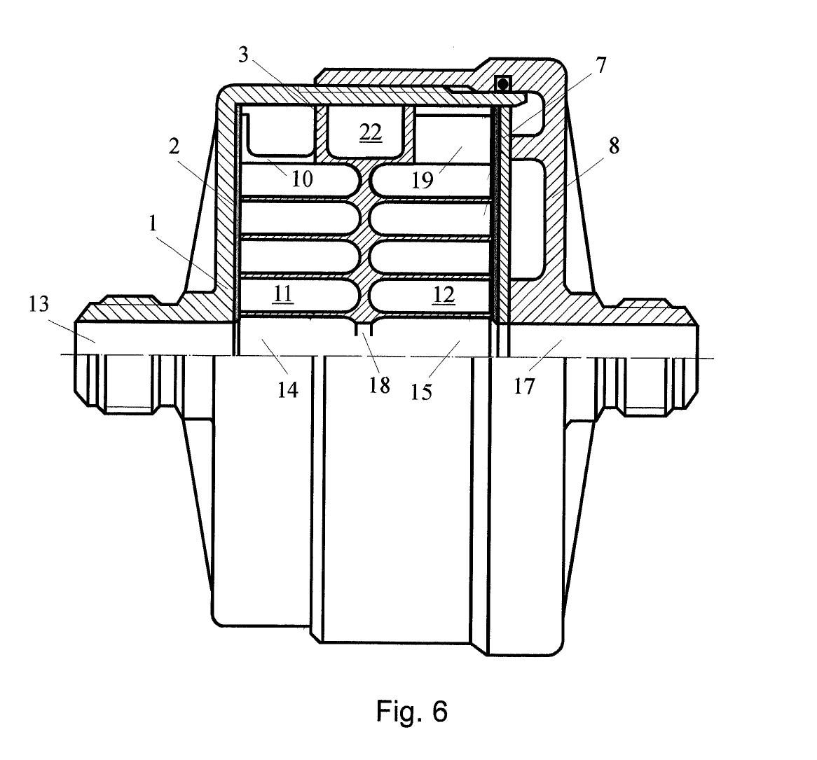

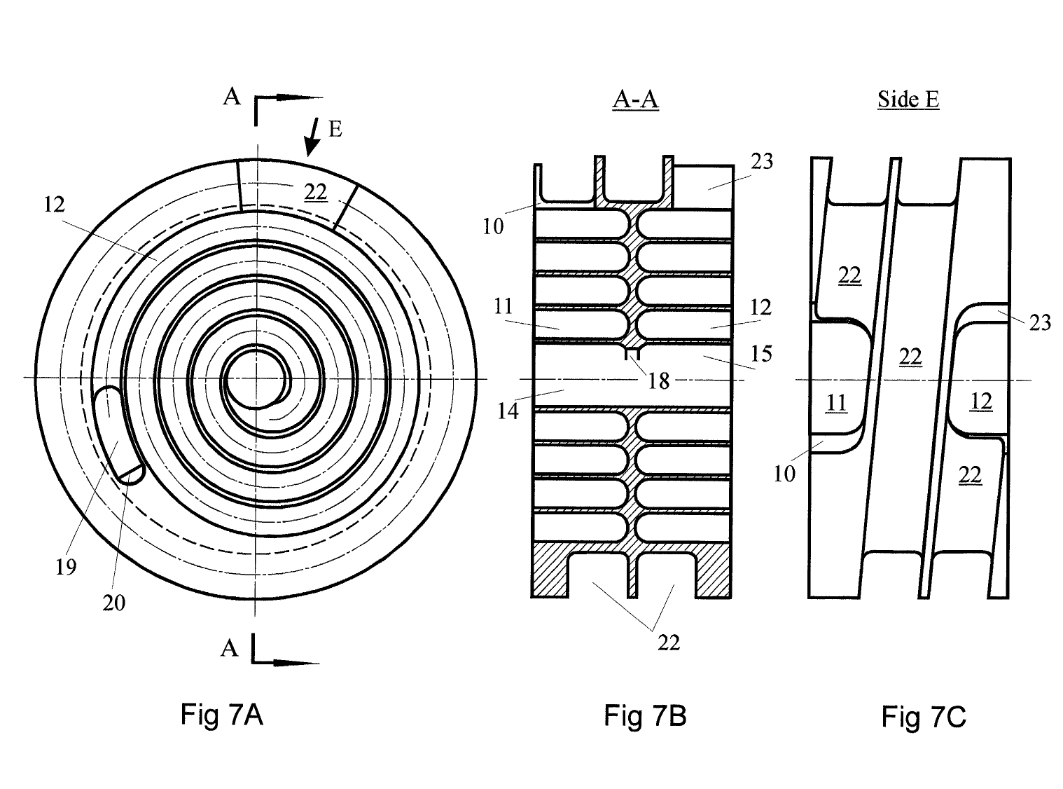

FIGS. 6, 7 show a composite interference pulsation dampener with one modified interference disk This disk differs from the disks described above only in the design of the secondary channel, which has additional notches 22 along the circular perimeter of the disk and additional orifice 23. This construction is suitable for hydraulic systems with average-frequency pulsations and where compactness of the device is the important factor. Such a disk allows to reach a compromise between a requirement for minimal disk size and restriction on a given interval of pulsations' frequencies.

Other notations in the FIGS. 6, 7 are the same as in FIGS. 1-5.

### EXAMPLE 4

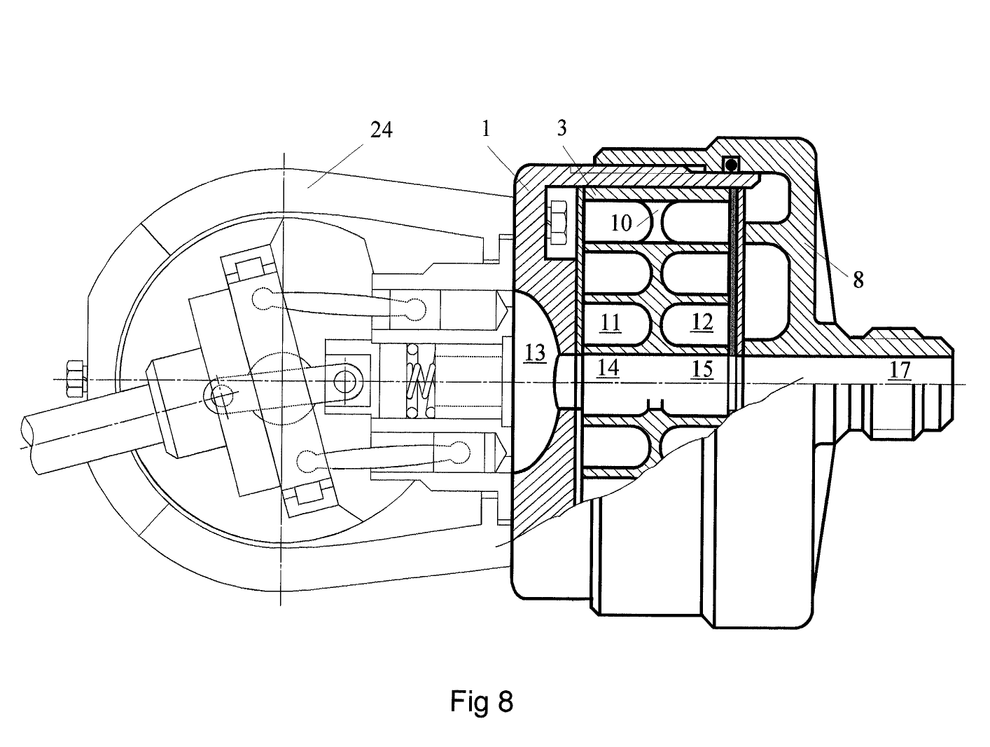

FIG. 8 shows the construction of a pulseless pump consisting of a regular pump 24 and an embedded cover 1 with input channel 13, interference disk 3, and output cover 8 with output channel 17.

Other notations in the FIG. 8 are the same as in FIGS. 1-7.

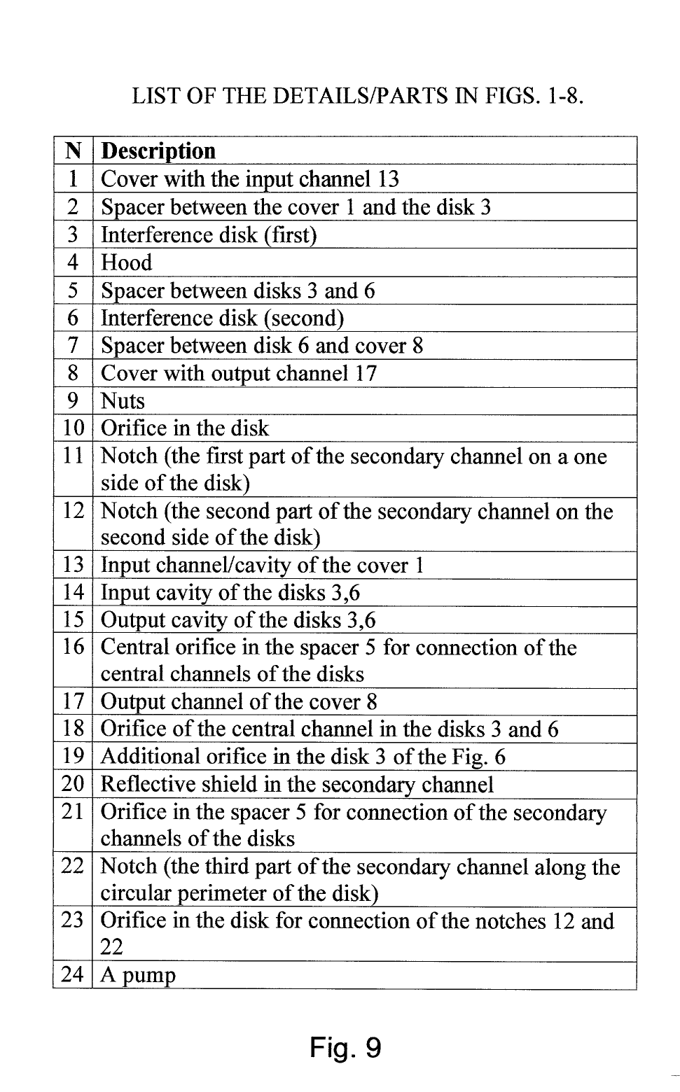

FIG. 9 is the list of details/parts of the invention shown in FIGS. 1-8.

FIG. 10 demonstrates the principle of the device's work. Graph 1 shows amplitudes of pulsations in the central channel of the disk Graph 2 shows amplitudes of pulsations in the secondary charnel of the disk. Graph 3 shows amplitudes of pulsations in the output cavity of the disk (after the interference).

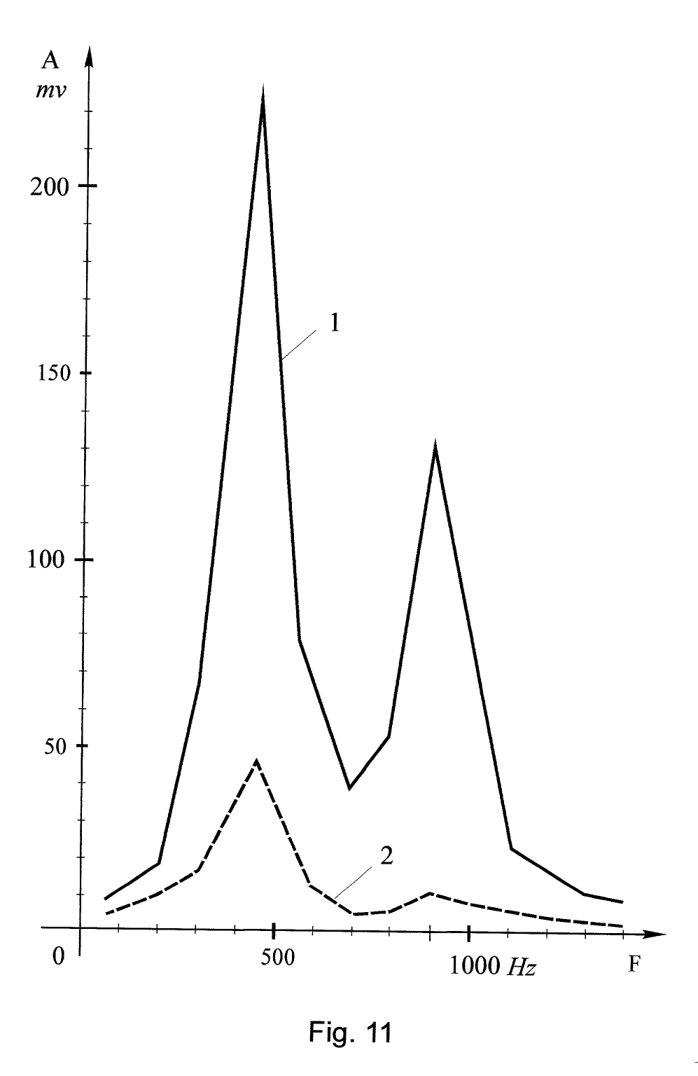

FIGS. 11-14 present the results of experimental tests of dampeners with one interference disk of different types. A set of sensors was placed on the pipes of the hydraulic systems and into the flows of liquids. The signals from the sensors were measured by a selective voltmeter. The experiments were accomplished on airplane's hydraulic systems with pressures in the flow of 2900-3100 psi.

In FIG. 11 amplitudes of pulsations in the hydraulic systems in a range of frequencies are shown (1—without the dampener, 2—with the dampener).

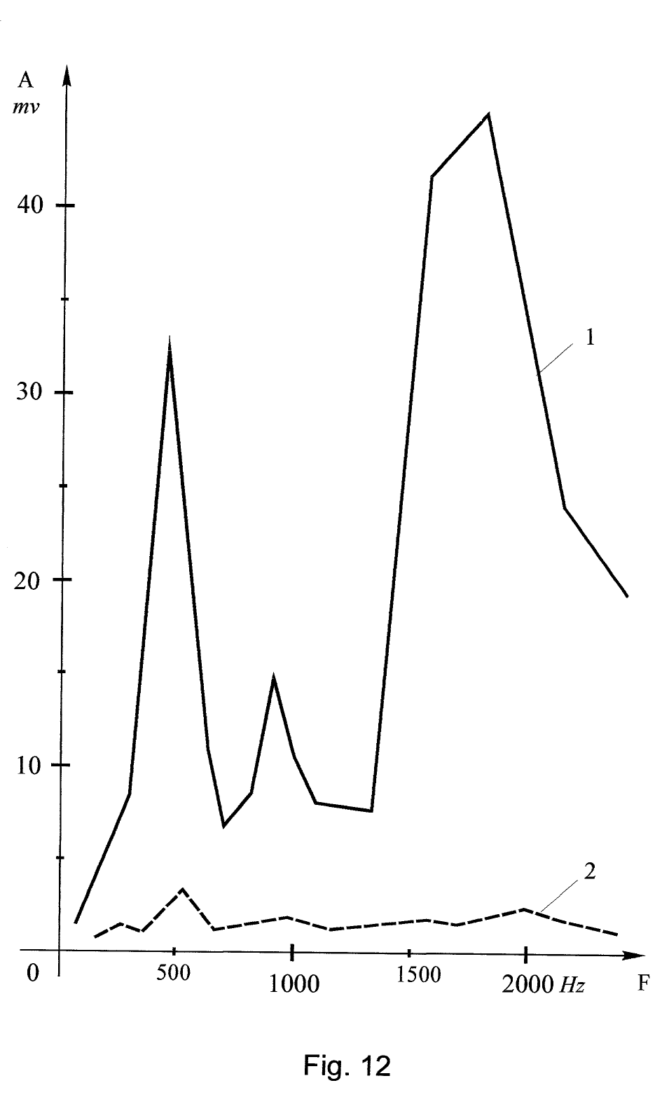

In FIG. 12 amplitudes of the hydraulic system's pipe vibrations are shown (1—without the dampener, 2—with the dampener).

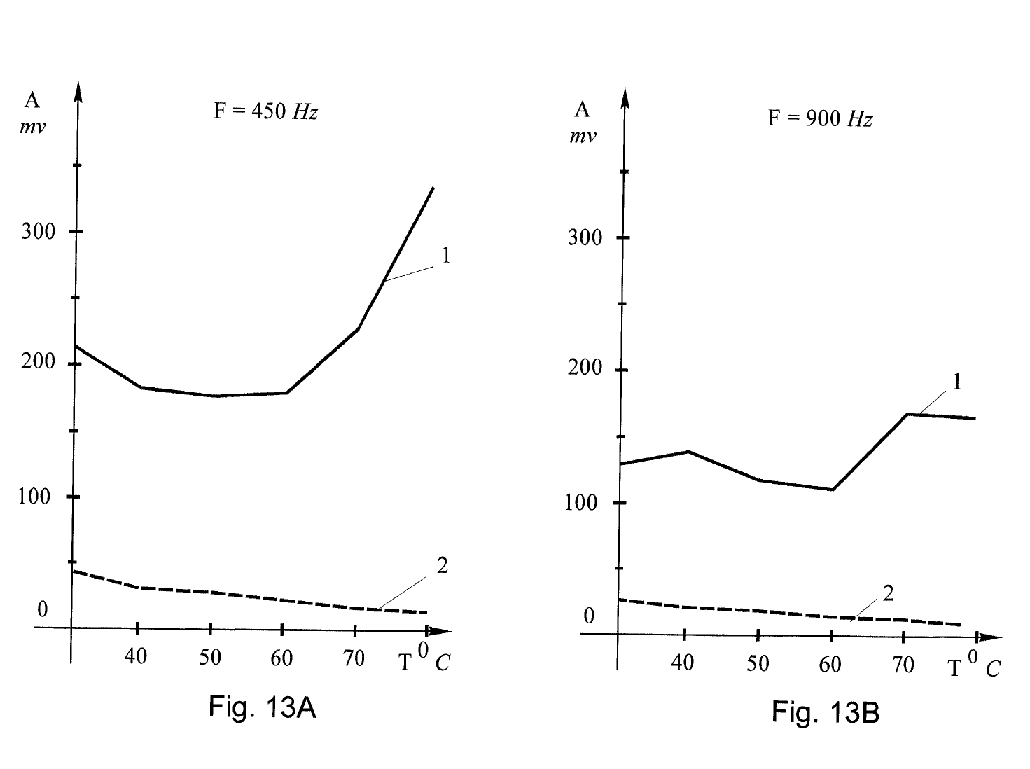

In FIG. 13A amplitudes of pulsations in the hydraulic systems on the interval of liquid's temperature for the frequency—450 Hertz are shown (1—without the dampener, 2—with the dampener).

In FIG. 13B amplitudes of pulsations in the hydraulic systems on the interval of liquid's temperature for the frequency 900 Hertz are shown (1—without the dampener, 2—with the dampener).

This invention is not to be limited to only the embodiments illustrated in the drawings, because the drawings are merely utilized to illustrate some of the wide variety of uses of this invention.

1. A composite interference pulsation dampener for reducing the effects of pulsations and accompanying vibrations and noises in a hydraulic/pneumatic system for wide spectrums of frequencies, temperatures, pressures, and velocities of a flow in the system, which is highly reliable and compact, comprised of one or several simple/modified interference disks placed consequently in a desired combination.

2. The pulsation dampener as in claim 1, wherein the interference disk or disks are placed in a pumping device.

3. The pulsation dampener as in claim 1, wherein spacers with additional orifices separate the interference disks.

4. The pulsation dampener as in claim 1, wherein central and secondary channels of the interference disks form common central and secondary channels of the device.

5. A modified interference disk for minimization of the dampener and maximization of efficiency on wide ranges/intervals/spectrums of frequencies consisting of a hard disk, central channel in the disk, and secondary channels on the sides of the disk in the form of an optimal combination of spirals, segments, and arcs.

6. A modified interference disk as in claim 5, wherein a secondary channel may have additional orifices/holes.

7. A modified interference disk as in claim 5, wherein a secondary channel may have shields/plates to form reflective waves.

8. A modified interference disk as in claim 5, wherein areas of intersections in the channels are optimized according to the required criteria/performance.
